(19) United States
(12) Patent Application Publication
(10) Pub. No.: US 2014/0352789 A1
(43) Pub. Date: Dec. 4, 2014

(54) CHARGE VALVE SEALING SYSTEM

(71) Applicant: Honeywell International, Inc., Morristown, NJ (US)

(72) Inventors: RICKY GOV, MONTEREY PARK, CA (US); PETER ZHENG, RANCHO PALOS VERDES, CA (US); KAREN KUO, LA PALMA, CA (US)

(21) Appl. No.: 13/907,813

(22) Filed: May 31, 2013

(51) Int. Cl. F16K 27/02

(52) U.S. Cl. CPC F16K 27/02
USPC 137/1; 137/234.5

(57) ABSTRACT

A charge valve system includes a valve fitting housing a valve and a cap sealing the fluid from escaping the charge valve system. The valve fitting may include a fitting exterior surface diameter. The cap may include an inner sidewall diameter greater than the fitting exterior surface diameter so that the cap inner sidewall may be spaced from the fitting exterior surface. In some embodiments, the cap inner sidewall may be slid over the valve fitting into compressed engagement sealing the cap over the valve fitting.

### BACKGROUND OF THE INVENTION

The present invention generally relates to valves, and more particularly to a charge valve sealing system.

In refrigeration systems, fluid leakage may be common and a problematic issue. It may be common to store refrigerant until needed and then use valves to discharge the refrigerant from its storage and charge a refrigerant system. However, valves tend to wear out over time thus creating a leak path for the stored refrigerant. As a result, valuable time may be expended detecting the presence of a leak, replacing the valves, evacuating the system and then recharging the system. It may be typical to use caps to cover these valves in an effort to prevent refrigerant from leaking out and depleting the refrigerant stores.

A common approach to prevent leakage may include covering valves with a threaded on cap mating the cap threads to threads commonly used on charging tools. This sealing method relies on the threads to effectively stop the flow of refrigerant. However, the refrigerant may easily pass through the cap threads because of the molecular size of the refrigerant. There are occasions where technicians, in an effort to prevent leakage, will tend to over-torque the cap. This may strip the cap threads and/or the charging tool threads. The stripping may result in leaks and in preventing proper engagement of refrigeration charging tools.

As can be seen, there is a need for a charge valve sealing system that seals the escape of refrigerant while preventing damage to the charging tool.

### SUMMARY OF THE INVENTION

In one aspect of the present invention, a charge valve system comprises a valve core; a valve stem in the valve core; a valve fitting including a central opening configured to house the valve core; an exterior surface on the valve fitting configured to couple with a charging tool; a cap slidably fitted over the valve fitting; and an interior sidewall of the cap spaced from the exterior surface of the valve fitting.

In another aspect of the present invention, a charge valve system comprises a valve; a valve fitting configured to house the valve; a threaded exterior surface on the valve fitting configured to mate with a charging tool; a neck of the valve fitting including one or more grooves configured for receipt of an O-ring, the neck having an outer diameter greater than an outer diameter of the valve fitting; a cylindrical cap including an interior wall configured to slidably fit over the valve fitting; an interior wall diameter of the cap indexed to seal over the outer diameter of the neck and over the one or more grooves.

In yet another aspect of the present invention, a method of sealing a charge valve comprises providing a valve fitting, including a neck and a fitting head attached to the neck, the neck having a diameter greater than an outer diameter of the fitting head; providing a cap with an internal sidewall diameter corresponding to the diameter of the neck; and sliding the cap over the valve fitting into compressed engagement with the neck of the valve fitting.

These and other features, aspects and advantages of the present invention will become better understood with reference to the following drawings, description and claims.

### BRIEF DESCRIPTION OF THE DRAWINGS

FIG. 1 is a cross-sectional side view of a charge valve sealing system according to an exemplary embodiment of the present invention; and

FIG. 2 is a flowchart of a method of sealing a charge valve according to another embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features. However, any single inventive feature may not address any of the problems discussed above or may only address one of the problems discussed above. Further, one or more of the problems discussed above may not be fully addressed by any of the features described below.

The present invention generally provides a charge valve sealing system that may prevent refrigerant from leaking and escaping from a cap covering a valve. The cap may cover the valve and seal around a fitting housing the valve without stripping any threads around the fitting.

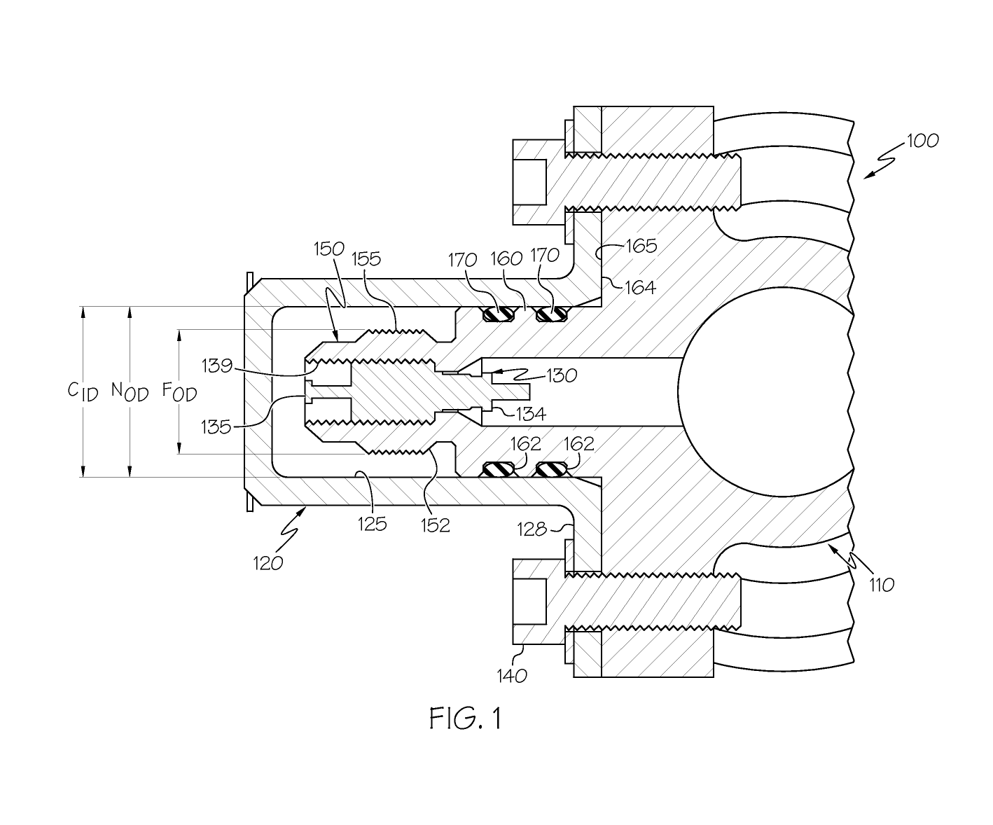

Referring now to FIG. 1, a charge valve system 100 generally includes a valve assembly 110 and a cap 120 sealing the valve assembly 110. The valve assembly 110 may include a valve 130 and a valve fitting 150.

The valve 130 may include a valve core 134 and a valve stem 135 configured to release fluid, for example, refrigerant from a fluid source (not shown). The valve 130 may in some embodiments, be a Schrader valve. The valve 130 may be threaded for receipt by the valve fitting 150.

The valve fitting 150 may be configured to house the valve 130 and couple to a charging tool (not shown). An internal wall 139 of the valve fitting 150 may define an opening for receipt of the valve 130. The internal wall 139 may be threaded to couple with threaded valves 130. The valve fitting 150 may include a fitting head 152 with an exterior surface 155. The diameter of the exterior surface 155 is shown as F_{OD}. In some embodiments, the exterior surface 155 may be threaded to receive threaded type charging tools. The valve fitting 150 may include a neck 160 below the fitting head 152 and above a fitting base 164. The outer diameter of the neck 160 is shown as N_{OD}. In an exemplary embodiment, the diameter N_{OD} of the neck 160 may be greater than the diameter F_{OD} of the fitting head 152. The neck 160 may include one or more grooves 162, which may receive an O-ring 170 or some other impermeable gasket. In some embodiments, the valve fitting 150 may include a flange 165 extending radially from the base 164.

In an exemplary embodiment, the cap 120 may be configured to slide over the valve assembly 110. The cap 120 may include an internal sidewall 125. The inner diameter of the cap 120 defined by the internal sidewall 125 is shown as C_{ID}. The internal sidewall 125 may be smooth and may be spaced from the exterior surface 155 of the valve fitting 150 when the cap 120 covers the valve assembly 110. For example, the inner diameter C_{ID} of the cap 120 may be indexed to or correspond to the outer diameter N_{OD} of the neck 160. In some embodiments, the cap 120 may include a flange 128 where the cap 120 may be sealed over the valve assembly 110 by bolting the cap flange 128 to the valve fitting flange 165 via bolts 140.

When the cap 120 is placed over the valve assembly 110, it may be appreciated that interior wall 125 may avoid contact with the exterior surface 155 of the valve fitting 150. With the inner diameter C_{ID} of the cap 120 being indexed to the outer diameter N_{OD} of the neck 160, the O-rings 170 may be compressed into place by the pressure exerted by the interior sidewall 125 sliding over the O-rings 170 thus sealing any fluids escaping the valve assembly 110 from exiting the cap 120. In addition, in embodiments including the cap flange 128, fluid may be prevented from escaping by securing the cap 120 at the flange 128 thus avoiding any external pressure on the interior sidewall 125 which prevents damage to the exterior surface 155 of the valve fitting 150.

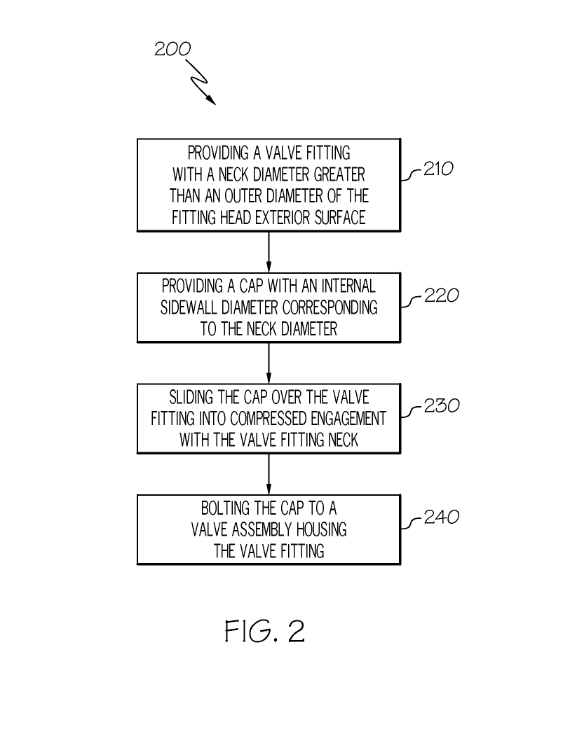

Referring now to FIG. 2, a method 200 of sealing a charge valve is shown according to an exemplary embodiment of the present invention. The elements in method 200 may reference elements of FIG. 1. In block 210, the valve fitting 150 may be provided that includes a neck diameter N_{OD} that may be greater than an outer diameter F_{OD} of the exterior surface 155 of the valve fitting head 152. In block 220, the cap 120 may be provided which may include an internal sidewall diameter C_{ID} corresponding to the neck diameter N_{OD}. In block 230, the cap 120 may be slid over the valve fitting 150. The cap 120 may slide over, for example, the O-rings 170 compressing the O-rings 170 into a pressurized engagement with the internal sidewall 125 thus sealing any fluids escaping the valve assembly 120 from exiting the cap 120. In block 240, the cap 120 may be bolted onto the valve assembly 110 for example, by bolting the cap flange 128 to the valve assembly flange 165, thus preventing the cap 120 from sliding off the valve fitting 150 and providing a redundant seal at the interface of the flanges 128 and 165.

It should be understood, of course, that the foregoing relates to exemplary embodiments of the invention and that modifications may be made without departing from the spirit and scope of the invention as set forth in the following claims.

We claim:

1. A charge valve system, comprising:
a valve core;
a valve stem in the valve core;
a valve fitting including a central opening configured to house the valve core;
an exterior surface on the valve fitting configured to couple with a charging tool;
a cap slidably fitted over the valve fitting; and
an interior sidewall of the cap spaced from the exterior surface of the valve fitting.

2. The charge valve system of claim 1, further comprising a flange at a base of the fitting, wherein the cap is configured to seal onto the flange.

3. The charge valve system of claim 1, further comprising threads on the exterior surface of the valve fitting.

4. The charge valve system of claim 3, wherein the interior sidewall does not contact the threads.

5. The charge valve system of claim 1, further comprising one or more O-rings on the valve fitting, wherein the interior sidewall of the cap is in compressed engagement with the one or more O-rings.

6. A charge valve system, comprising:
a valve;
a valve fitting configured to house the valve;
a threaded exterior surface on the valve fitting configured to mate with a charging tool;
a neck of the valve fitting including one or more grooves configured for receipt of an O-ring,
the neck having an outer diameter greater than an outer diameter of the valve fitting;
a cylindrical cap including an interior wall configured to slidably fit over the valve fitting; and
an interior wall diameter of the cap indexed to seal over the outer diameter of the neck and over the one or more grooves.

7. The charge valve system of claim 6, further comprising a valve fitting flange extending radially from a base of the neck, wherein the cap is fastened to the valve fitting flange.

8. The charge valve system of claim 6, further comprising:
a valve fitting flange extending radially from a base of the neck; and
a cap flange at a base of the cap bolted onto the valve fitting flange.

9. A method of sealing a charge valve, comprising:
providing a valve fitting, including a neck and a fitting head attached to the neck, the neck having a diameter greater than an outer diameter of the fitting head;
providing a cap with an internal sidewall diameter corresponding to the diameter of the neck; and
sliding the cap over the valve fitting into compressed engagement with the neck of the valve fitting.
